(19) United States
(12) Patent Application Publication
(10) Pub. No.: US 2024/0409312 A1
(43) Pub. Date: Dec. 12, 2024

(54) STORAGE SYSTEM

(71) Applicant: Autostore Technology AS, Nedre Vats (NO)

(72) Inventor: Jørgen Djuve Heggebø, Langhus (NO)

(73) Assignee: Autostore Technology AS, Nedre Vats (NO)

(21) Appl. No.: 18/691,763

(22) PCT Filed: Sep. 9, 2022
(86) PCT No.: PCT/EP2022/075176

§ 371 Date: Mar. 13, 2024

(30) Foreign Application Priority Data
Sep. 17, 2021 (NO) 20211117

(51) Int. Cl. B65G 1/04

(52) U.S. Cl. CPC B65G 1/0464; B65G 1/0471

(57) ABSTRACT

A storage system includes a framework structure in which storage containers can be stored, a container lift device, and a container transfer device. The framework structure includes at least a first port column through which a storage container may be transferred to or from the container transfer device by the container lift device. The first port column includes an upper end, at which the container lift device is arranged when a storage container is to be lowered or lifted through the port column, and a lower end at which a container buffering assembly is arranged. The container buffering assembly features a container holder frame including a plurality of supports. The container holder frame is horizontally moveable between a first position under the lower end of the first port column and a second position away from the lower end of the first port column. The supports are actuatable between a holding position, in which the supports are configured to support a storage container, and a release position, in which a storage container may pass through the container holder frame in a vertical direction.

### FIELD OF THE INVENTION

The present invention relates to a storage system featuring a container buffering assembly.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminium profiles.

The framework structure 100 of the automated storage and retrieval system 1 comprises a rail system 108 (i.e. a rail grid) arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201,301,401 comprises a vehicle body 201a,301a,401a and first and second sets of wheels 201b,201c,301b,301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b,301b,201c,301c,401b,401c can be lifted and lowered, so that the first set of wheels 201b,301b,401b and/or the second set of wheels 201c,301c,401c can be engaged with the respective set of rails 110,111 at any one time.

Each prior art container handling vehicle 201,301,401 also comprises a lifting device 404 for vertical transportation of storage containers 106, e.g. raising a storage container 106 from, and lowering a storage container 106 into, a storage column 105, see FIG. 4. The lifting device comprises a lifting frame 17, guiding pins 19 and one or more gripping/engaging devices 27 which are adapted to engage corresponding gripping recesses 26, see FIG. 8b, in an upper rim of a storage container 106. The lifting frame 17 can be lowered from the vehicle 201,301,401 so that the position of the lifting frame with respect to the vehicle 201,301,401 can be adjusted in a third direction Z which is orthogonal the first direction X and the second direction Y. At least parts of the lifting device of the container handling vehicles 301,401 are shown in FIGS. 3 and 4 indicated with reference number 304,404. The lifting device of the container handling vehicle 201 is located within the vehicle body 201a in FIG. 2. The lifting device is suspended from lifting bands 16. The lifting bands 16 may provide power and communication between the container handling vehicle and the lifting frame and may be spooled on/off e.g. at least one rotatable lifting shaft to raise/lower the lifting device.

Conventionally, and also for the purpose of this application, Z=1 identifies the uppermost layer for storing storage containers below the rail system 108, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks.

WO2018/146304A1, the contents of which are incorporated herein by reference, illustrates a typical configuration of rail system 108 comprising rails and parallel tracks in both X and Y directions forming a rail grid.

In the framework structure 100, most of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

A storage system may also use port columns 119,120 to transfer a storage container between the rail system 108 on top of the framework structure 100 and a container transfer vehicle arranged under a lower end of the port column. Such storage systems and suitable container transfer vehicles are disclosed in WO 2019/238694 A1 and WO 2019/238697 A1, the contents of which are incorporated herein by reference.

A potential disadvantage of using a container transfer vehicle to retrieve and deliver storage containers from/to the lower end of a port column is the time dependency between the container transfer vehicle(s) and the container handling vehicles used to retrieve/deliver the storage containers through the port column. For instance, to optimize the use of a container transfer vehicle, it is preferred that after delivering a first storage container at a port column, the vehicle may retrieve a second storage container with a minimum of waiting time. In the prior art storage systems above, the latter will require the presence of a second container handling vehicle standing by for delivery of the second storage container through an additional port column instead of performing other operations. Consequently, although the use of the container transfer vehicle is optimized, the use of the container handling vehicles may be less efficient.

Similar disadvantages are also seen in other prior art storage systems, wherein container transfer vehicles are used to retrieve and deliver storage containers from/to the lower end of a port column. An example of such storage systems is disclosed in WO 2020/210558 A1.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the 20 storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the 25 above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling 30 vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the 35 temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage 40 container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

An object of the present invention is to provide an improved exchange of storage containers at a port column in a storage system featuring container transfer vehicles to deliver/retrieve storage containers at the lower end of the port column.

### SUMMARY OF THE INVENTION

The present invention is defined by the attached claims and in the following:

In a first aspect, the present invention provides a storage system comprising a framework structure in which storage containers can be stored, a container lift device and a container transfer device, the framework structure comprises at least a first port column through which a storage container may be transferred to or from
the container transfer device by the container lift device, the first port column comprises an upper end, at which the container lift device is arranged when a storage container is to be lowered or lifted through the port column, and a lower end at which a container buffering assembly is arranged,
wherein
   the container buffering assembly comprises a container holder frame comprising a plurality of supports;
   the container holder frame is horizontally moveable between a first position under the lower end of the first port column and a second position away from the lower end of the first port column;
   the supports are actuatable between a holding position, in which the supports are configured to support a storage container, and a release position, in which a storage container may pass through the container holder frame in a vertical direction.

The storage container may be transferred in a vertical direction to or from the container transfer device by the container lift device.

The container holder frame may comprise two opposite sides, and at least one support is arranged at each of the two opposite sides. The supports may be any element suitable for holding a storage container at a fixed level relative to the container holder frame. The supports may for instance be pivotable or extendable pins, rotatable half discs or horizontally moveable clamps, that may be actuated between a release position in which a storage container may pass through the container holder frame in a vertical direction and a holding position in which the supports will hold a storage container at a fixed level relative to the container holder frame. Actuation of the supports may be performed by any suitable type of electric, hydraulic or pneumatic actuator. The supports may be a fixed or integral part of the container holder frame and may for instance be actuated by contracting and/or extending an inner periphery of the container holder frame.

When in the first position, the container holder frame may be defined as being directly or straight below the lower end of the first port column.

In the first position, the container holder frame may receive or deliver a storage container from/to the container transfer device, may receive or deliver a storage container from/to the container lift device via the first port column and/or may allow passage of a storage container lifted/lowered by the container lift device through the container holder frame.

In an embodiment of the storage system, the container holder frame may be vertically movable, or the container transfer device comprises a vertically moveable container accommodation, for transferring a storage container between the container holder frame and the container transfer device.

In the first position, the vertically movable container holder frame may be lowered to receive or deliver a storage container from/to a container transfer device positioned under the container holder frame, may receive or deliver a storage container from/to the container lift device via the first port column and/or may allow passage of a storage container lifted/lowered by the container lift device through the container holder frame.

When in the second position the container holder frame does not overlap with the lower end of the first port column. In other words, when in the second position the container holder frame does not extend under the lower end of the first port column. When in the second position, the container holder frame may be horizontally removed from the lower end of the first port column, such that the container lift device may transfer a storage container directly to a container transfer device arranged below the first port column without passing through the container holder frame.

The container holder frame may be vertically movable relative to the level of the lower end of the first port column, such that a storage container may be transferred between the container holder frame and the container transfer device, i.e. such that the container holder frame may transfer a storage container from the lower end of the first port column to the container transfer device and from the container transfer device to the lower end of the first port column.

In the present specification, the term “port column” is intended to mean any port or opening through which a storage container may be transferred in a vertical direction.

In the present specification, the term “storage container” is intended to mean any goods holder unit having a bottom plate and side portions suitable for releasable connection to the container lift device, e.g. a bin, a tote, a tray or similar. The side portions may preferably comprise gripping recesses. The side portions are preferably sidewalls. The height of the sidewalls may vary depending on the intended use of the storage system and the goods to be stored. The gripping recesses may be arranged at an upper rim of the sidewalls. The outer horizontal periphery of the storage container is preferably rectangular.

In the present specification, the term “storage system” is intended to mean any system for storing various items/goods that may be accommodated in a storage container. The term “storage system” is thus intended to also cover systems such as e.g. vertical farming systems.

In an embodiment of the storage system, the container holder frame may be vertically movable between a lower position, in which a storage container is transferable between the container holder frame and the container transfer device, and an upper position, in which the container transfer device may move below a storage container held by the container holder frame.

When the container holder frame is in the upper or lower position, a storage container supported by the container holder frame may be retrieved by the container lift device.

When the container holder frame is in the first position and the upper or lower position and the supports are in the release position, the container lift device may lower a storage container to or retrieve a storage container from the container transfer device when the container transfer device is positioned under the first port column.

In an embodiment, the container accommodation of the container transfer device may be vertically movable between an upper position, in which a storage container is transferable between the container holder frame and the container transfer device, and a lower position, in which the container transfer device may move below a storage container held by the container holder frame. The container accommodation may be moved between the upper and lower position by a dedicated actuator assembly or by raising lowering a set of wheels of the container transfer device.

In an embodiment of the storage system, the container holder frame may be configured to move between the first position and the second position along a linear or arcuate path.

In an embodiment of the storage system, the container holder frame may have an inner periphery configured to allow passage of a storage container in a vertical direction when the supports are in the release position. The inner periphery of the container holder frame may define an opening through which a storage container may pass in a vertical direction. The inner periphery of the container holder frame may define a rectangular opening.

In an embodiment of the storage system, the container buffering assembly may comprise an actuator assembly arranged to move the container holder frame between the lower position and the upper position.

In an embodiment of the storage system, the container buffering assembly may comprise a shuttle to which the container holder frame is connected, the shuttle may be arranged to move the container holder frame in a horizontal direction between the first position and the second position.

In an embodiment of the storage system, the container holder frame may be vertically movable relative to the shuttle between the lower position and the upper position.

In an embodiment of the storage system, the container holder frame may be connected to the shuttle by an actuator assembly arranged to move the container holder frame between a lower position and an upper position. The container holder frame may be suspended below the shuttle by the actuator assembly. The actuator assembly may feature any actuator suitable for vertical movement of the container holder frame, such as a screw drive, a linear actuator, a hydraulic or electric piston.

In an embodiment of the storage system, the shuttle may have an inner periphery configured to allow passage of a storage container in a vertical direction. The inner periphery may define a rectangular opening. The rectangular opening of the shuttle may align with the rectangular opening of the container holder frame.

In an embodiment of the storage system, the container buffering assembly may comprise rails arranged at the lower end of the first port column, and the shuttle may moveably connected to the rails such that the container holder frame may move in the horizontal direction between the first position and the second position. The rails may extend from a position under the first port column to the second position, the second position may be any position horizontally removed from the lower end of the first port column, for instance a position under a second port column.

In an embodiment of the storage system, the shuttle may be pivotably connected to a rotary shaft having a vertical axis. The rotary shaft may be positioned adjacent to the first port column, e.g. within or below an adjacent/neighbouring column, such that the container holder frame may rotate between the first and the second position. In other words, the container holder frame may move along an arcuate path between the first and the second position. The rotary shaft may be driven by an electric motor.

In an embodiment of the storage system, the framework structure may comprise a second port column through which a storage container may be transferred by the container lift device, and the second position of the container holder frame is under a lower end of the second port column.

In the second position, when the second position is arranged below the lower end of a second port column, the container holder frame may receive or deliver a storage container from/to a container transfer device positioned under the container holder frame, may receive or deliver a storage container from/to the container lift device via the second port column and may allow passage of a storage container lifted/lowered by the container lift device through the container holder frame. When the container holder frame is vertically moveable, the container holder frame may be lowered to receive or deliver a storage container from/to a container transfer device positioned under the container holder frame, when in the second position.

In an embodiment, the storage system may comprise a third port column and a second container holder frame, i.e. an additional container holder frame identical to the container holder frame described above, the second container holder frame is horizontally moveable between a first position under the lower end of the third port column and a second position away from the lower end of the third port column.

In an embodiment of the storage system, the first port column, the second port column and the third port column may be arranged adjacent to each other.

In an embodiment of the storage system, the container transfer device may be a container transfer vehicle comprising wheels, for horizontal movement of the container transfer vehicle, and a container accommodation upon which a storage container may be supported.

The container accommodation is configured to receive a storage container from above. i.e. the container accommodation may be configured such that a storage container may be lowered onto the container accommodation by the container holder frame or the container lift device.

The container accommodation of the container transfer device may be vertically moveable, such that the container accommodation may be raised to deliver a storage container to the container holder frame or receive a storage container from the container holder frame.

In an embodiment of the storage system, the container lift device may comprise a lifting assembly which is suspended from one or more spoolable lifting elements and arranged to be raised or lowered in order to raise or lower a releasably attached storage container within the first port column. The lifting assembly may comprise a lifting frame for releasable attachment to an upper section of a storage container.

The lifting frame may comprise guide pins arranged at the corners of the lifting frame. The guide pins may extend in an upwards direction above an upper surface of the lifting frame to ensure guiding of the lifting frame when it is lowered a distance below the lower end of the first port column.

In an embodiment of the storage system, the framework structure may comprise an upper rail system, and the container lift device may be a container handling vehicle comprising at least one set of wheels for moving the container handling vehicle in a horizontal direction on the upper rail system. The at least one set of wheels may be suitable for moving the container handling vehicle in two perpendicular horizontal directions on the upper rail system.

The upper rail system may comprise a vertical opening defining at least an upper part of the first port column. The vertical opening may be a grid space defined by perpendicular rails of the upper rail system. In some embodiments, the first port column may be an opening in the upper rail system. The opening allowing vertical transfer of a storage container from a topside of the upper rail system to a position below the upper rail system.

In a second aspect, the present invention provides a container buffering assembly for a storage system, the storage system comprising a framework structure, in which storage containers can be stored, a container lift device and a container transfer device, the framework structure comprises at least a first port column through which a storage container may be transferred by the container lift device; wherein
the container buffering assembly comprises a container holder frame;
the container holder frame is moveably connectable at a lower end of the first port column such that the container holder frame may move in a horizontal direction between a first position under the lower end of the first port column and a second position away from the lower end of the first port column; and
the container holder frame comprises a plurality of supports, the supports being actuatable between a holding position, in which the supports are configured to support a storage container, and a release position, in which a storage container may pass through the container holder frame in a vertical direction.

In an embodiment, the container buffering assembly comprises a shuttle, wherein
the container holder frame is connected to the shuttle by an actuator assembly, and the shuttle is moveably connectable at a lower end of the first port column such that the container holder frame and the shuttle may move in a horizontal direction between the first position and the second position; and
the actuator assembly is arranged to vertically move the container holder frame relative to the shuttle between a lower position, in which a storage container is transferable between the container holder frame and the container transfer device, and an upper position, in which the container transfer device may move below a storage container held by the container holder frame.

In an embodiment, the container buffering assembly may comprise a set of rails, the rails are connectable at the lower end of the first port column, and the container holder frame and/or the shuttle is moveably connected to the set of rails such that the container holder frame and shuttle may move in a horizontal direction between the first position and the second position.

In an embodiment, the container buffering assembly may comprise multiple horizontal ceiling profiles and vertical support profiles, the ceiling profiles being configured to support the lower ends of column profiles defining port columns and the vertical support profiles configured to support the multiple horizontal ceiling profiles. The height of the vertical support profiles being sufficient to allow a container transfer device to move under the container holder frame while carrying a storage container. The rails may be connectable at the lower ends of the first port column via the ceiling profiles.

In further embodiments of the second aspect, the container buffering assembly may comprise any of the features of the container buffering assembly in the storage system of the first aspect.

In a third aspect, the present invention provides a method of transferring storage containers in a storage system according to the first aspect, the method comprising the steps of:
moving the container holder frame to the first position;
moving a container transfer device, carrying a first storage container, to a position below the first port column;
lowering the container holder frame towards the container transfer device (i.e. moving the container holder frame to the lower position) or vertically raising a container accommodation of the container transfer device, while the supports are in the release position;
actuating the supports into the holding position to support, or interact with, the first storage container;
lifting the container holder frame and the first storage container towards the lower end of the port column (i.e. moving the container holder frame to the upper position), or lowering the container accommodation of the container transfer device; and
moving the container holder frame and the first storage container to the second position.

In an embodiment, the method may comprise a step of lowering a second storage container via the first port column to the container transfer device by use of the container lift device when the container holder frame and the first storage container has been moved to the second position.

In an embodiment, the method may comprise a step of moving the container transfer device and the second storage container away from the first port column. That is, the container transfer device and the second storage container is moved away from the first port column in a horizontal direction.

In an embodiment, the method may comprise the steps of moving the container holder frame and the first storage container to the first position, and retrieving the first storage container by use of the container lift device after the container transfer device and the second storage container have been moved away from the first port column.

In all aspects of the invention, the container transfer device may be arranged below the container holder frame.

In all aspects of the invention, the framework structure may comprise vertical column profiles defining the at least first port column. The first port column may be defined by four of the vertical column profiles. Each of the column profiles may comprise four corner sections, wherein each corner section is arranged to accommodate a corner of a storage bin, and the inner periphery of the port column may be defined by a rectangle delimited by the inner periphery of a corner section of each of the four column profiles defining the port column. The inner periphery of a container holder frame, and optionally the inner periphery of a corresponding shuttle, may be substantially equal to the inner periphery of the port column.

In all aspects of the invention, the first port column may be defined by four of the vertical column profiles and each vertical column profile has a centrepoint or centreline, the four centrepoints or centrelines defining the corners of a rectangular boundary line. An outer periphery of the shuttle and/or the corresponding, or connected, container holder frame may be configured to fit within the boundary line.

In all aspects of the invention, the first port column may be defined by four of the vertical column profiles, and each of the column profiles comprises four corner sections, wherein each corner section is arranged to accommodate a corner of a storage bin, and the inner periphery of the port column may be defined by a rectangle delimited by the inner periphery of a corner section of each of the four column profiles defining the port column. The inner periphery of a container holder frame, and optionally the inner periphery of a corresponding shuttle, may be substantially equal to the inner periphery of the port column.

### BRIEF DESCRIPTION OF THE DRAWINGS

Embodiments of the invention is described in detail by reference to the following drawings:

FIG. 1 is a perspective view of a framework structure of a prior art automated storage and retrieval system.

FIG. 2 is a perspective view of a prior art container handling vehicle having a centrally arranged cavity for carrying storage containers therein.

FIG. 3 is a perspective view of a prior art container handling vehicle having a cantilevered section for carrying storage containers underneath.

FIG. 4 are side views of the container handling vehicle in FIG. 3, wherein a container lifting assembly is shown.

FIGS. 5-14 show a first exemplary embodiment of a storage system according to the invention.

FIGS. 15-19 show a second exemplary embodiment of a storage system according to the invention.

FIGS. 20-21 show a third exemplary embodiment of a storage system according to the invention.

FIGS. 22-23 show a fourth exemplary embodiment of a storage system according to the invention.

FIGS. 24-25 show a fifth exemplary embodiment of a storage system according to the invention.

FIGS. 26a and 26b show a sixth exemplary embodiment of a storage system according to the invention.

### DETAILED DESCRIPTION OF THE INVENTION

In the following, embodiments of the invention will be discussed in more detail with reference to the appended drawings. The drawings are not intended to limit the invention to the illustrated subject-matter.

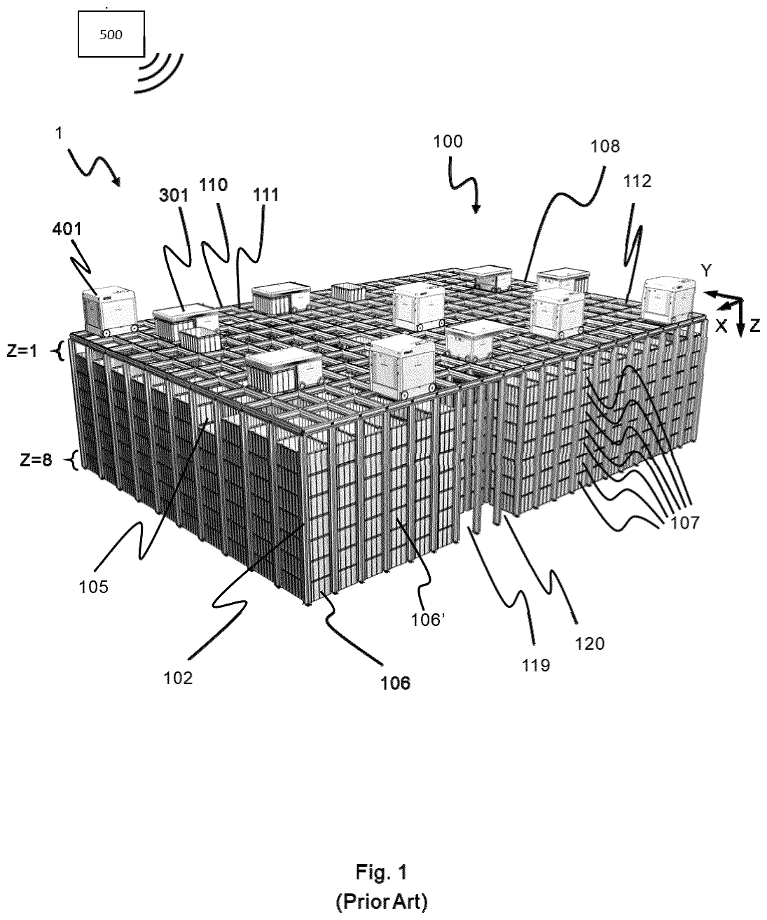

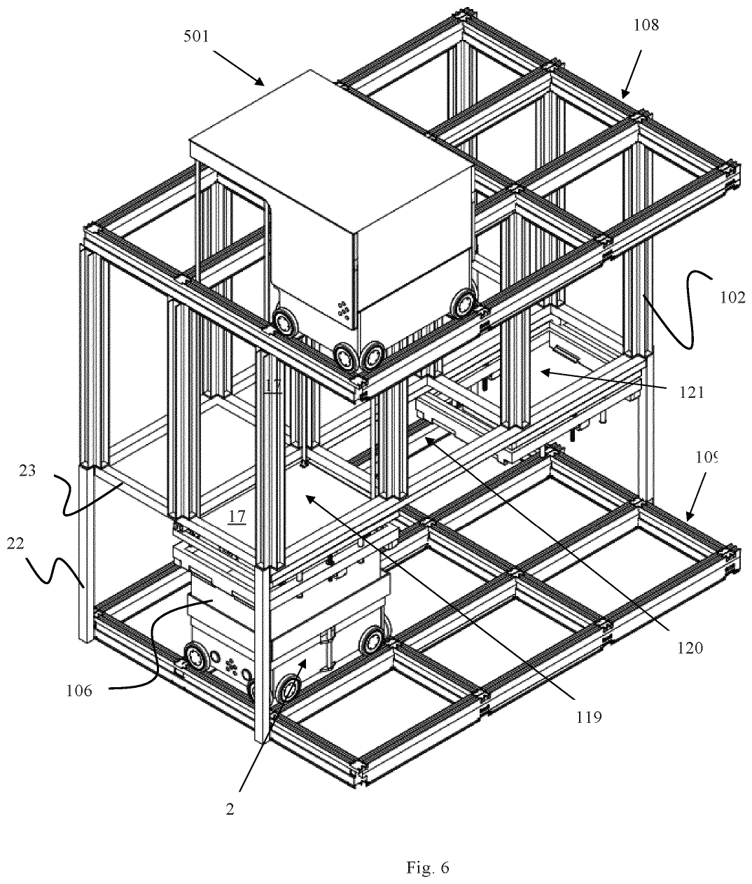

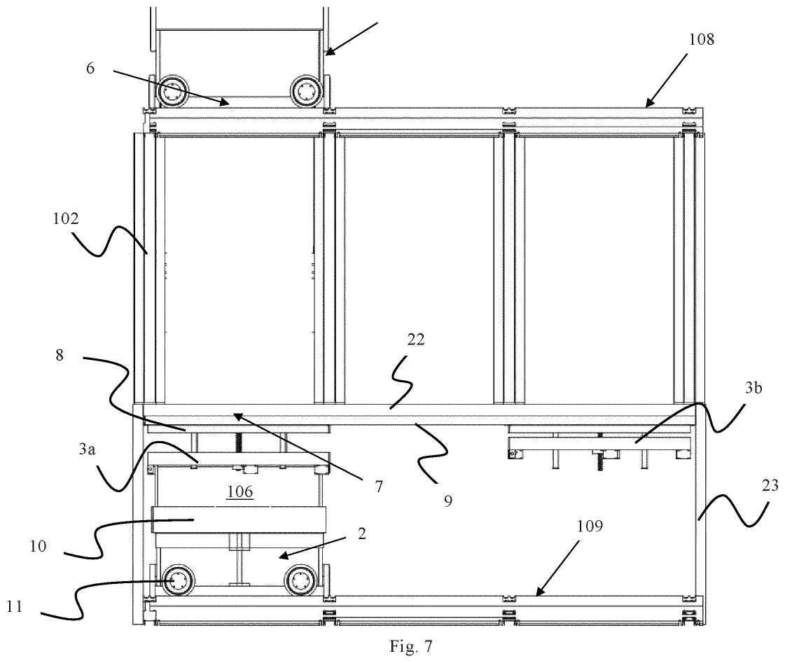

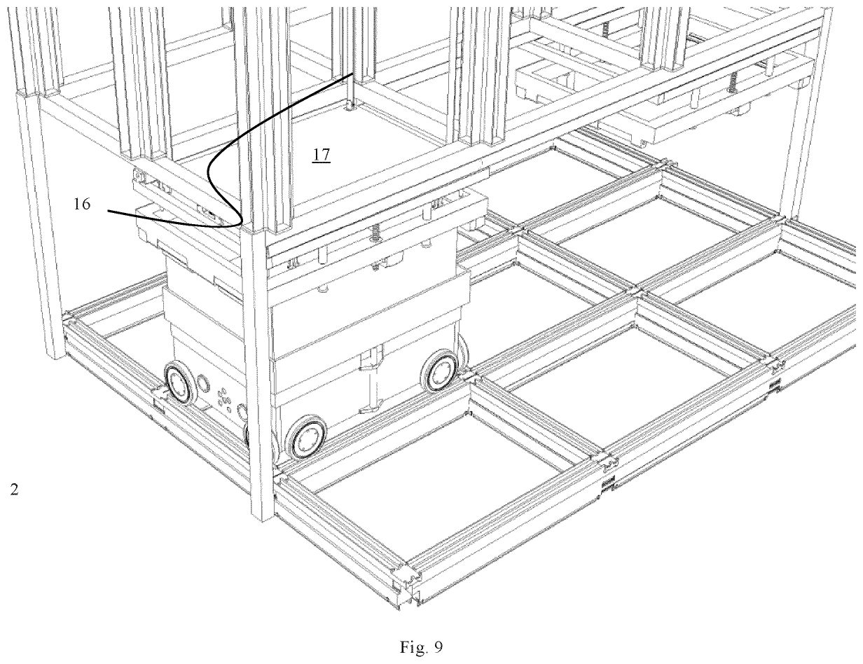

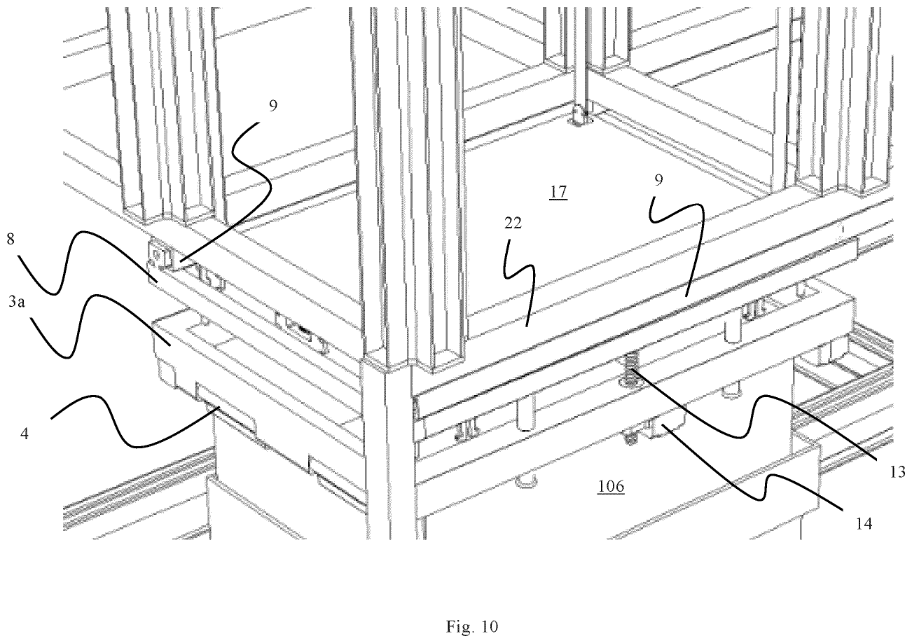

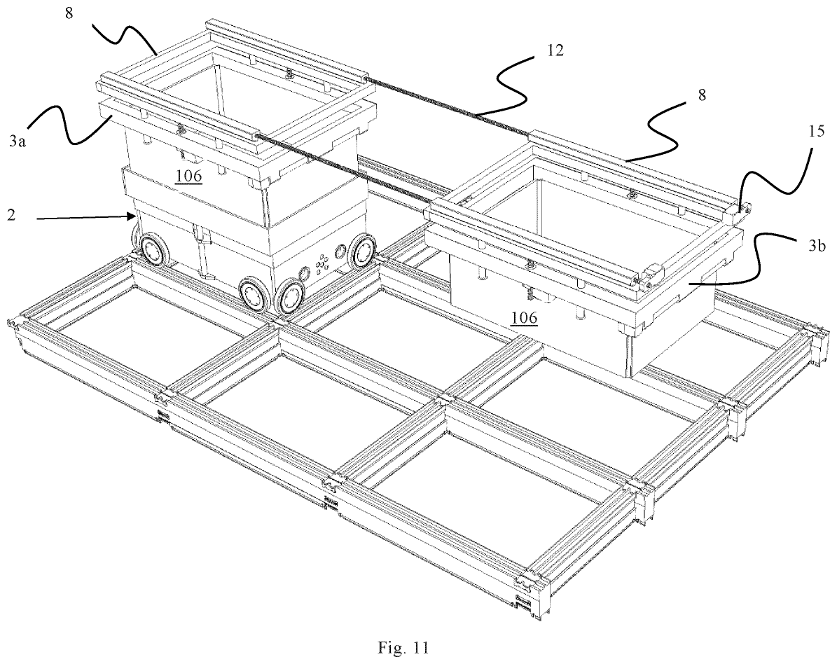

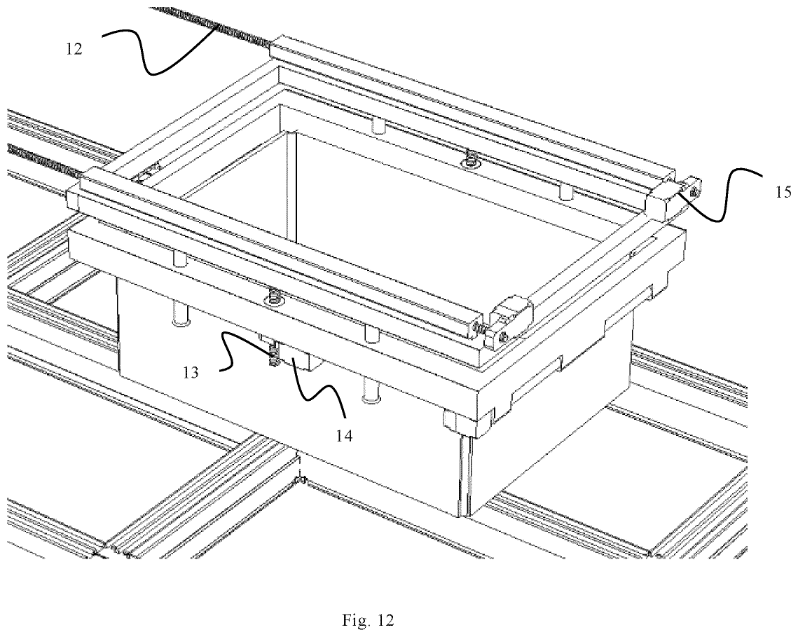

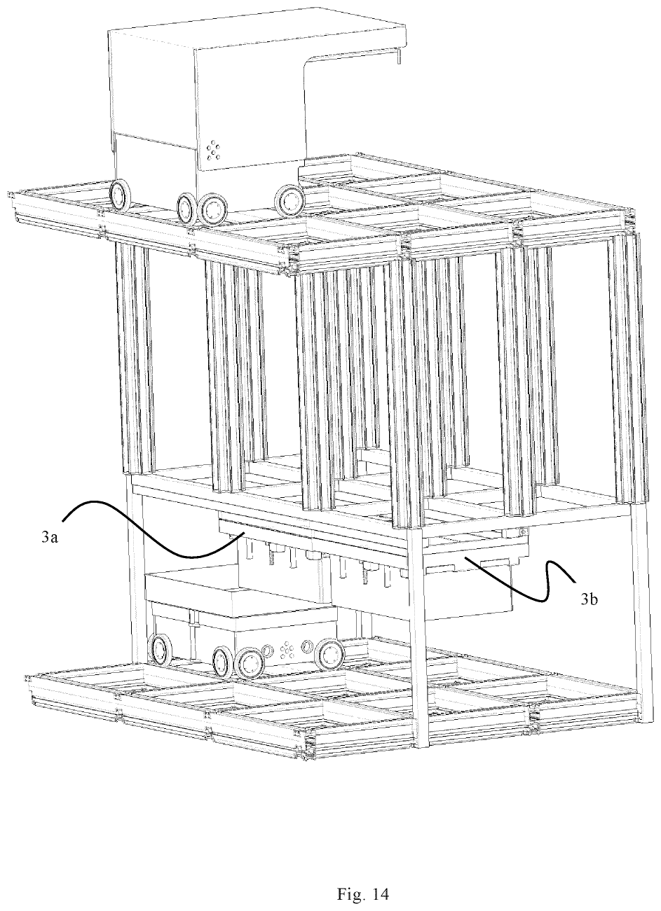

A first exemplary embodiment of a storage system 1 according to the invention is shown in FIGS. 5-14. The storage system features a plurality of storage columns 105 in which storage containers 106 may be stored stacked on top of one another as described for the prior art storage system in FIG. 1. However, in FIGS. 5-14 only a section of the storage system comprising port columns 119,120,121 and a container buffering assembly 3a,3b,8,9 is shown.

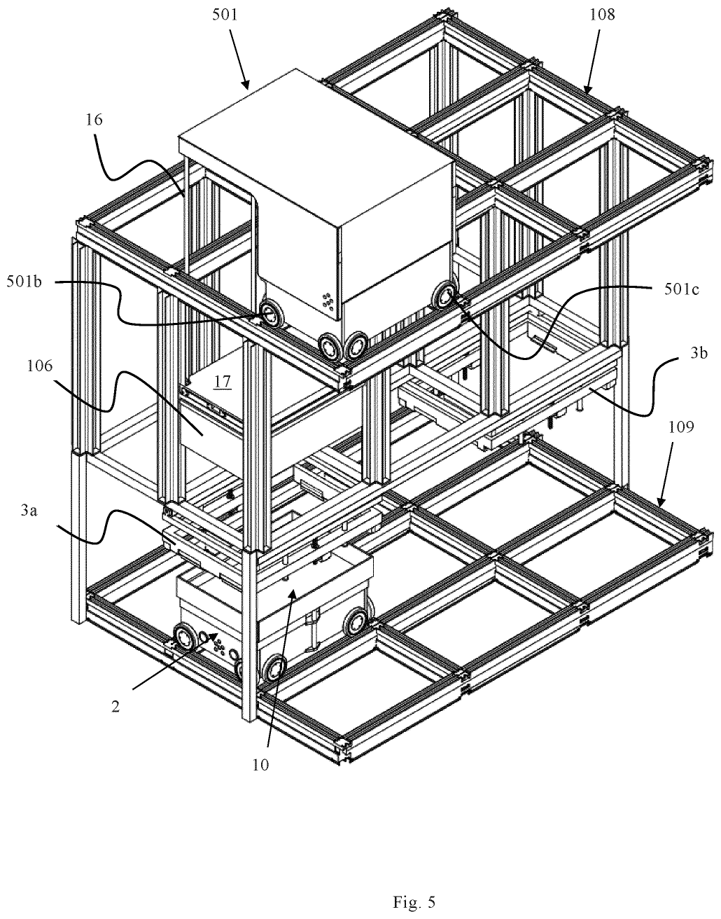

The storage system features a framework structure 100, a container handling vehicle 501 (i.e. a container lift device) and a container transfer vehicle 2 (i.e. a container transfer device). The framework structure comprises vertical column profiles 102 defining a first port column 119, a second port column 120 and a third port column, through which columns a storage container 106 may be transferred by use of the container handling vehicle 501. The container handling vehicle features a lifting assembly comprising a lifting frame 17 for releasable attachment to an upper section of a storage container 106. The lifting frame 17 is suspended from lifting bands 16 (i.e. spoolable lifting elements) and is arranged to be raised or lowered to raise or lower a releasably attached storage container 106 within the port columns 119,120,121, see FIGS. 5 and 6. The lifting bands 16 may be spooled off and on at least one lifting shaft (not shown) of the container handling vehicle. Guide pins 19, see FIG. 4, arranged at the corners of the lifting frame 17 ensure guiding of the lifting frame when it is lowered a distance below the lower ends 7 of the port columns 119,120,121.

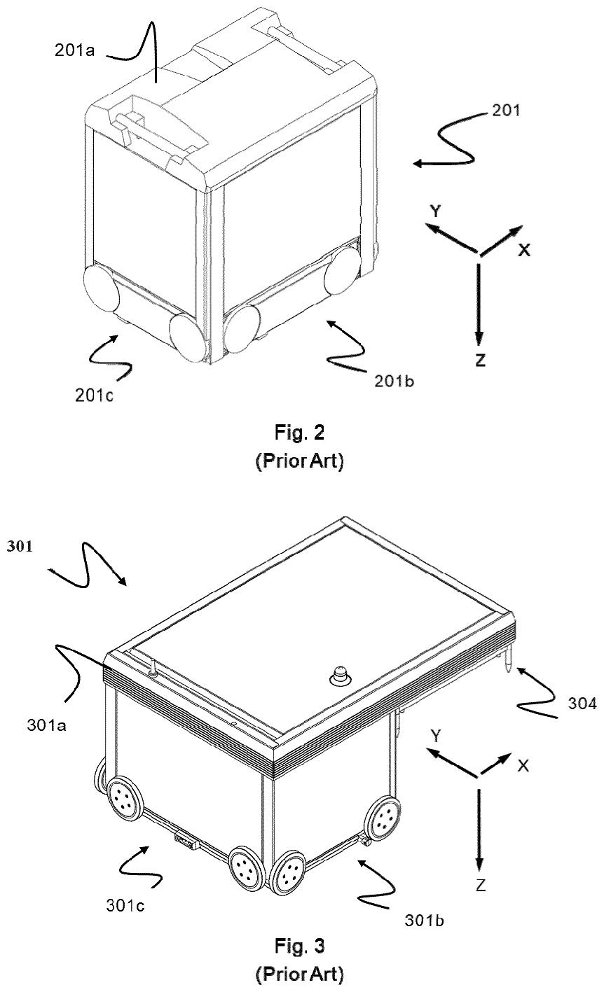

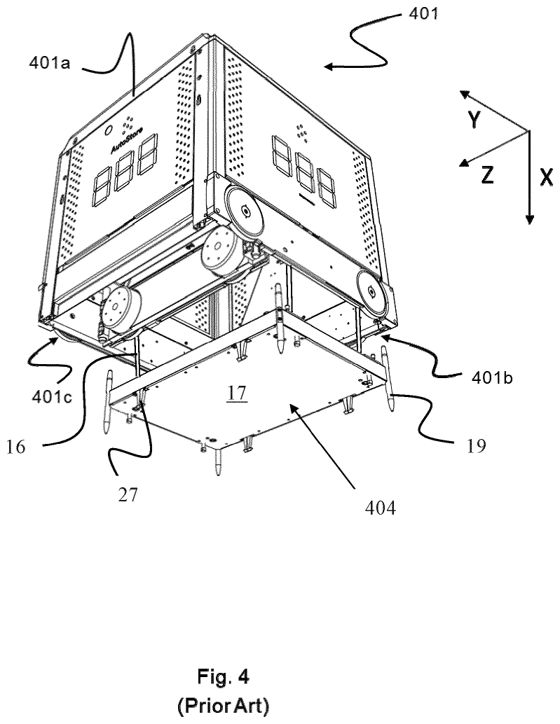

The illustrated container handling vehicle 501 functions in the same manner as the prior art vehicles shown in FIGS. 2-4 and described above. However, depending on the configuration of the storage system, the container buffering assembly may provide a highly advantageous functionality irrespective of whether the storage system comprises a mobile container lift device, e.g. a wheel-driven container handling vehicle 501, or an immobile container lift device arranged at or above the upper end of the first port column in a fixed position. An exemplary storage system featuring an immobile container lift device in which the present invention would be highly advantageous is disclosed in WO 2020/210558 A1.

Each of the port columns 119,120,121 comprises an upper end 6, at which the container handling vehicle 501 may be arranged when a storage container 106 is to be lowered or lifted through the port column and a lower end 7 at which a container buffering assembly is arranged. The lower ends of the column profiles 102 defining the port columns 119,120,121 are supported upon multiple horizontal ceiling profiles 22 and vertical support profiles 23. To allow adjacent port columns 119,120,121 the ceiling profiles 22 arranged between two adjacent port columns are narrower than the column profiles 102.

In the first exemplary embodiment, the container buffering assembly features a first and a second container holder frame 3a,3b. Each container holder frame is connected to a corresponding shuttle 8 and comprises a plurality of supports 4 for releasably holding a storage container 106.

The shuttles 8 in this embodiment are moveably connected to parallel rails 9 arranged at the lower ends 7 of the port columns 119,120,121, i.e. the rails are connected to the ceiling profiles 22, such that the first container holder frame 3a may move in a horizontal direction between a first position under a lower end 7 of the first port column 119 and a second position arranged under the second port column 120 away from the lower end of the first port column. The second container holder frame 3b may move in a horizontal direction between a first position under a lower end 7 of the third port column 121 and the second position arranged under the second port column 120.

Although the presence of two container holder frames 3a,3b may increase the flexibility of the container buffering assembly, a single container holder frame, e.g. the first container holder frame 3a, is sufficient to obtain an improved exchange of storage containers at the first port column 119. Having the second position arranged under the second port column 121 also provides an increased flexibility due to the possibility of retrieving a storage container 106 from the first or second container holder frame 3a,3b by the container handling vehicle 501 when the respective container holder frame 3a,3b is in the second position. However, it is sufficient that the second position is removed from the first position such that the first and/or third port column may be used without interference from the container frame arranged in the second position.

The horizontal movement of each shuttle 8, and consequently the container holder frames 3a,3b, relative to the rails 9 is obtained by a drive assembly featuring screws 12 and an electric motor 15. The screws 12 are arranged within the rails and the shuttle 8 is driven along the screws by use of the electric motor 15. The horizontal movement may alternatively be obtained by any suitable linear actuator or drive assembly featuring various types of screw drives, driven wheels/rails, rack/pinion and sprocket/chain.

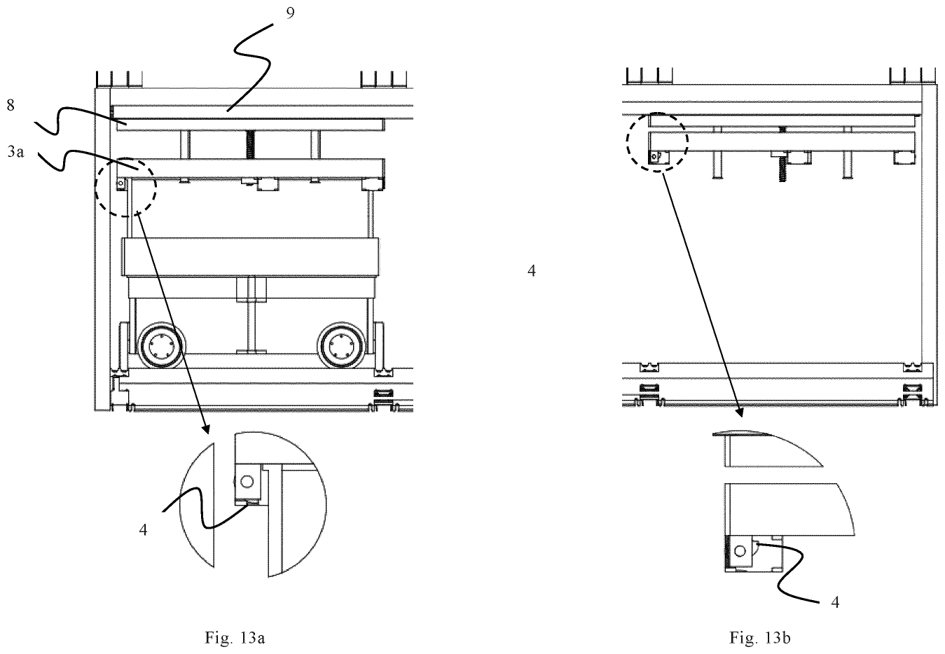

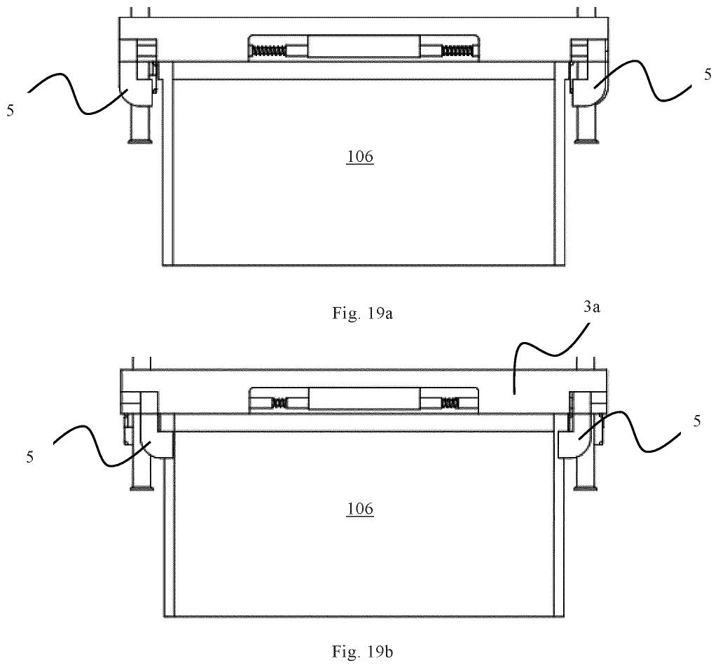

The supports 4, see FIGS. 10 and 13a/13b, are arranged at two opposite sides of the container holder frame 3a,3b. The supports 4 may pivot (i.e. are actuatable) between a holding position, see FIG. 13b, in which the supports are configured to support a storage container 106, and a release position, see FIG. 13a, in which a storage container may pass through the container holder frame 3a,3b in a vertical direction. An alternative type of supports in the form of clamps 5 is shown in FIGS. 19a and 19b. Provided the supports are configured to allow passage of a storage container through the container holder frame when in the release position and hold a storage container when in the holding position, any alternative type of supports may be used, e.g. in the form of clamps as shown in FIGS. 19a and 19b. The supports 4 in the first embodiment are arranged to pivot around a horizontal axis between the release position and the holding position but may in further embodiments be arranged to pivot around a vertical axis or to move along a linear path.

Each of the shuttles 8 and the corresponding container holder frame 3a,3b feature an inner periphery defining an opening. The openings are larger than an outer periphery of a storage container 106 to allow vertical passage of the storage container 106 through the shuttle 8 and the corresponding container holder frame 3a,3b when the supports 4 are in the release position. In this way a container holder frame 3a,3b, which is generally a rectangular frame, can encircle the sides of a storage container 106, and when necessary project the supports 4 inwardly to extend under a lip or other projection of the storage container 106 and thereby support the storage container 106 on the supports 4 and from the container holder frame 3a,3b. Both the shuttle 8 and corresponding container holder frame 3a,3b may be configured as rectangular frames. The openings of the shuttle 8 and the corresponding container holder frame 3a,3b are aligned.

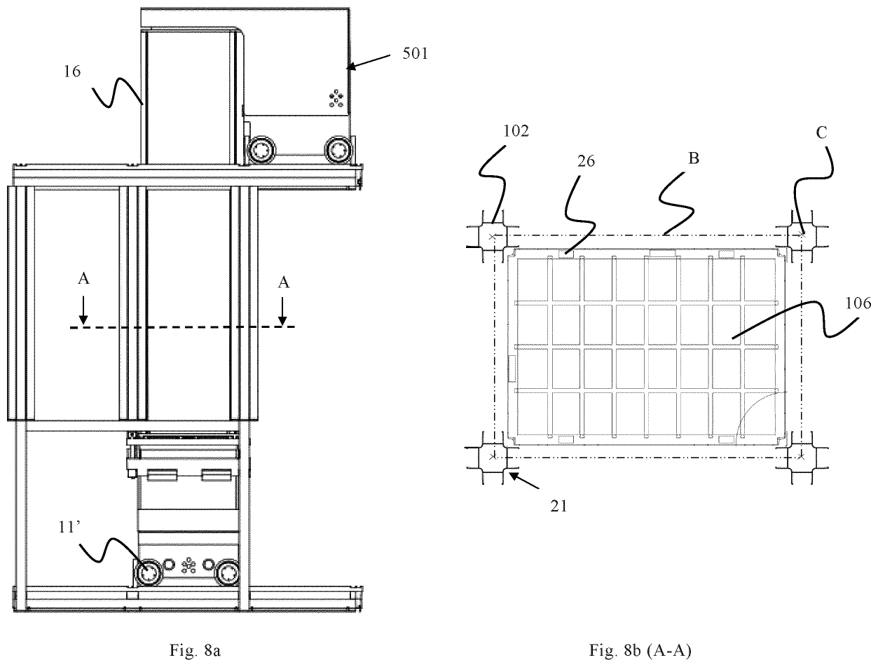

The port columns 119,120,121 are each defined by four of the vertical column profiles 102, see FIG. 8b. The vertical column profiles have a centre point or line C defining the corners of a rectangular boundary line B and four corner sections 21 arranged to accommodate a corner of a storage container 106. In the cross-section in FIG. 8a, the storage container 106 is shown for illustrative purposes. Adjacent port columns, such as the first port column 119 and the second port column 120 have one side of the boundary line in common. An outer periphery of a shuttle 8 and the corresponding container holder frame 3a,3b may advantageously be configured to fit within the boundary line B. The size of the outer periphery of the shuttle 8 and the corresponding container holder frame 3a,3b will then allow the first container holder frame 3a and the second container holder frame 3b to be arranged simultaneously under two adjacent port columns, e.g. the first port column 119 and the second port column 120.

The container holder frames 3a,3b are vertically movable relative to the corresponding shuttle 8 between a lower position, in which a storage container 106 may be transferred between one of the container holder frames 3a,3b and the container transfer vehicle 2, and an upper position, in which the container transfer vehicle 2 may move under a storage container 106 held by one of the container holder frame 3a,3b. The vertical movement is obtained by an actuator assembly comprising a screw 13 and an electric motor 14. In alternative embodiments, the actuator assembly may comprise any assembly suitable for providing a linear vertical movement of the container holder frame 3a,3b relative to the shuttle 8, such assemblies may include a rack/pinion, a worm drive/gear or an electrical or hydraulic piston/cylinder.

In the first exemplary embodiment, the storage system features a lower rail system 109 on which the container transfer vehicle 2 may move in two perpendicular directions by use of wheels 11,11′. The lower rail system 109 may preferably have the same type of rails and dimensions as the upper rail system 108 to allow for a highly accurate positioning of the container transfer vehicle 2 relative to the port columns 119,120,121. Suitable container transfer vehicles 2 are disclosed in for instance WO 2019/238694 A1.

One of the advantages of the container buffering assembly is that it allows a container transfer vehicle 2 to both deliver and receive storage containers 106 at the same port column in a highly time efficient manner. For instance, a container transfer vehicle 2 may deliver a first storage container 106 to the first container holder frame 3a arranged in the first position under the first port column 119, the container holder frame 3a may then move to the second position and the transfer vehicle 2 may subsequently receive a second storage container 106 from the container handling vehicle 501 via the first port column 119. In other situations, the container handling vehicle 501 may deliver or receive a storage container to/from the container holder frame 3a and thus avoid having to wait for a container transfer vehicle 2. For instance, the container handling vehicle 501 may lower a first storage container to the first container holder frame 3a in the first position, then the first container holder frame 3a is moved away from the first port column 119 to the second position before a container transfer vehicle 2 enters under the first port column 119 with a second storage container which the container handling vehicle 501 retrieves. The container transfer vehicle 2 may then retrieve the first storage container by moving below the first container holder frame 3a in the second position or by moving the first container holder frame 3a to the first position. In all of these situations, the container buffering assembly minimizes the time dependency of the container handling vehicle 501 and the container transfer vehicle 2.

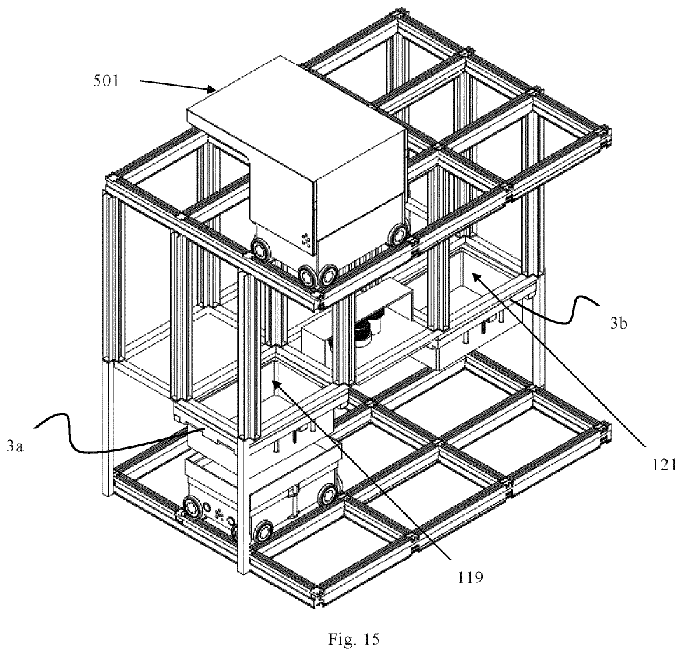

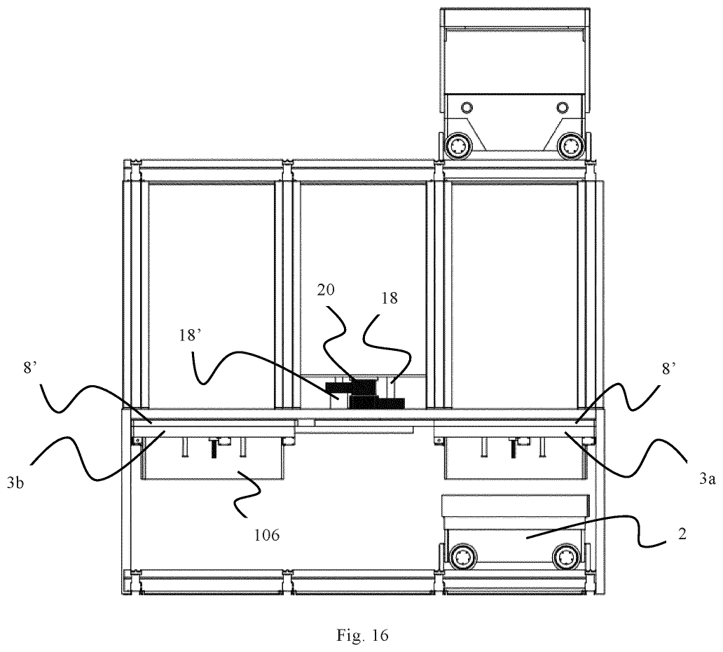

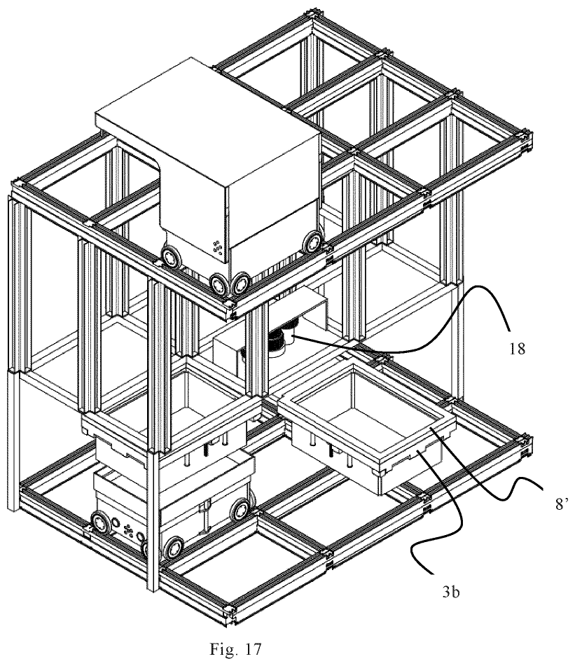

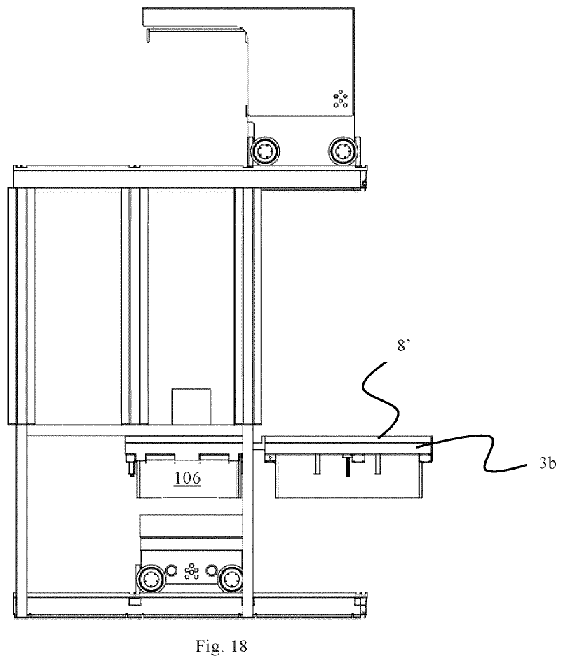

A second exemplary embodiment of a storage system according to the invention is shown in FIGS. 15-19. The main difference of the second embodiment in view of the first embodiment in FIGS. 5-14 is the manner in which the shuttles 8′, and consequently the corresponding container holder frames 3a,3b, are configured to move between a first position under a first port column 119 and a second position away from the first port column 119. To obtain an arcuate horizontal movement path, each of the shuttles 8′ are pivotably connected to a corresponding rotary shaft 18,18′ having a vertical axis adjacent to the first port column 119 and the third port column 121 respectively. The rotary shaft 18,18′ being driven by an electric motor 20. The first container holder frame 3a may rotate between the first position under the first port column 119 to a second position away from the first port column 119. Correspondingly, the second container holder frame 3b may rotate between the first position under the third port column 121 to the second position away from the third port column 121. In this embodiment, the second position is not arranged under a port column, but the solution will nevertheless provide an improved exchange of storage containers at the first and third port columns 119,121. The remaining features of the storage system are as described above in connection with the first exemplary embodiment.

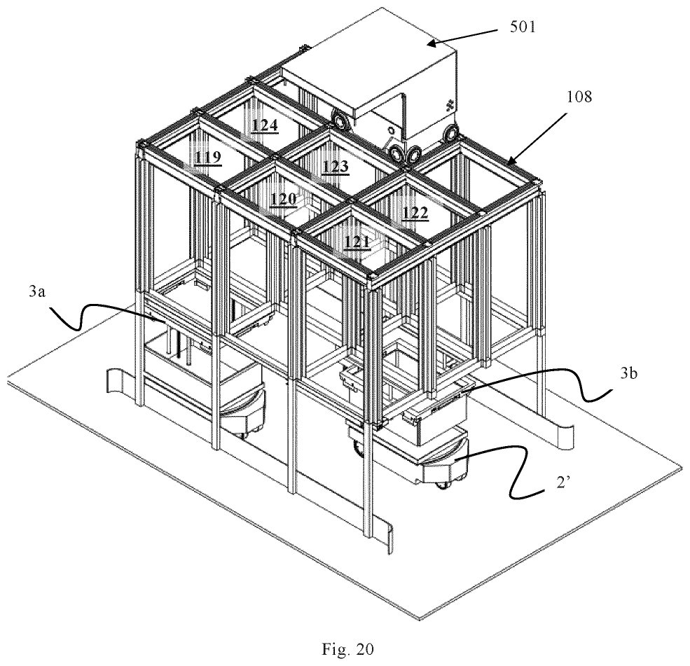

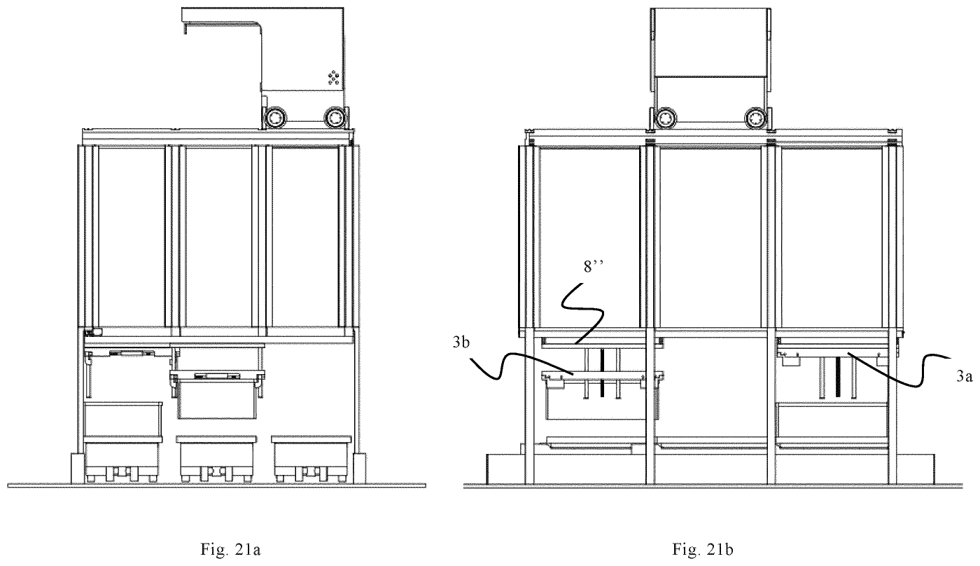

A third exemplary embodiment of a storage system according to the invention is shown in FIGS. 20-21. In the third embodiment, the shuttles 8″ are connected to a rail system 9′ arranged at the lower ends 7 of a plurality of port columns 119-124. The rail system 9′ and the shuttles 8″ are configured to allow horizontal movement in two perpendicular directions, such that a container holder frame 3a,3b may move between a plurality of positions arranged under adjacent port columns. The first container holder frame 3a may for instance move directly from a first position under the first port column 119 to a second position under the second port column 120 or, say, to a sixth position under the sixth port column 124. The horizontal movement may be obtained by various configurations of the connection between the shuttles 8″ and rail system 9′. Suitable connections are disclosed in US 2008/0213073 A1. In the third embodiment, the container transfer vehicles 2′ are automated guided vehicles (AGV) not requiring a lower grid system 109 as described above for the first and second embodiment. Automated guided vehicles suitable for the inventive storage system are disclosed in WO 2019/238697 A1.

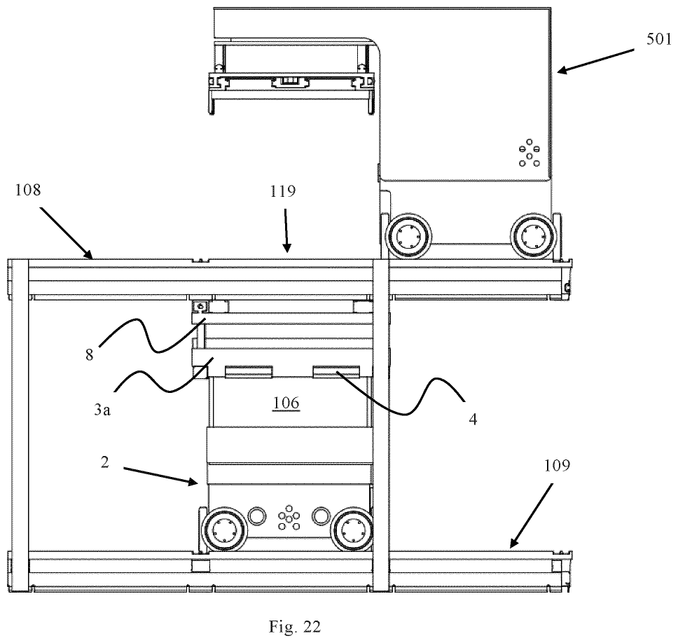

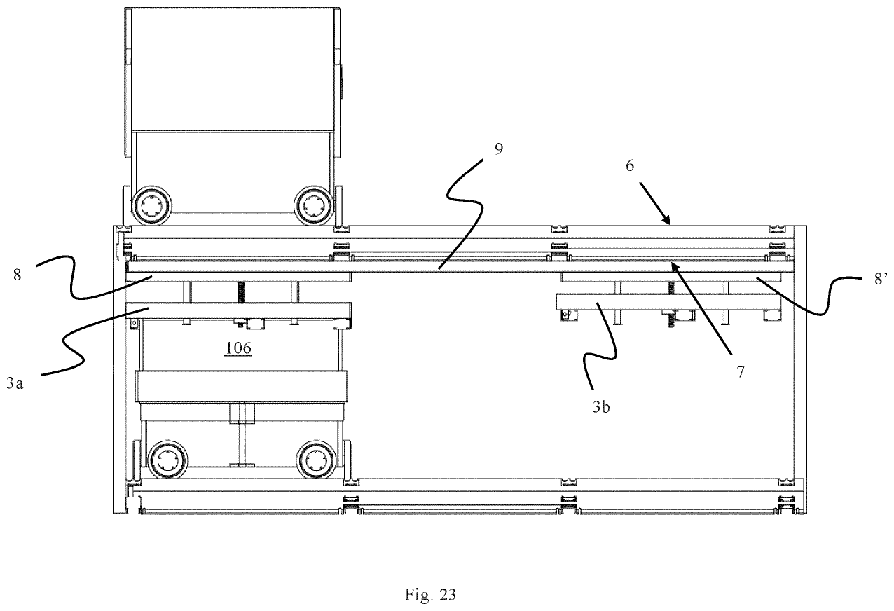

A fourth exemplary embodiment of a storage system according to the invention is shown in FIGS. 22 and 23. In the fourth embodiment, the container buffering assembly is identical to the one in the first exemplary embodiment described above. However, in the fourth embodiment the first port column 119 is only defined by the opening in the upper rail system 108. This solution is suitable when the container transfer vehicle 2 may be arranged at a higher level than in the first embodiment and provides the same advantages as described above.

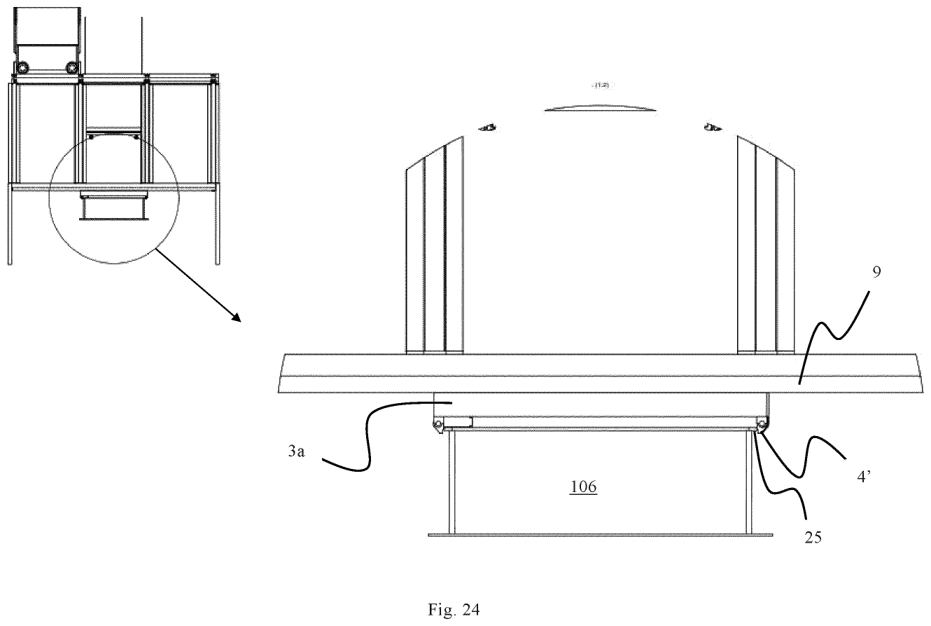

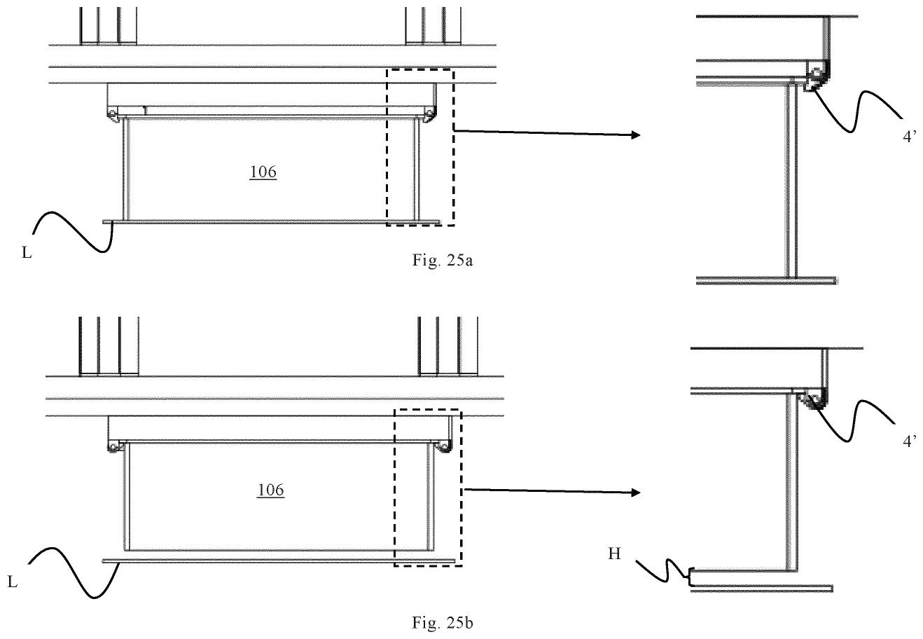

A fifth exemplary embodiment of a storage system according to the invention is shown in FIGS. 24 and 25a/b. In the fifth embodiment, the vertical movement transferring the storage container 106 between the container accommodation 10 (illustrated as level L) of a container transfer vehicle 2 and a container holder frame 3a is obtained by the movement of the supports 4′ themselves. In FIG. 24, a storage container has been moved below the container holder frame and the supports are in the release position. In FIG. 25a, the supports 4′ are in an intermediate position in contact with an outer rib 25 of the storage container 106. During the final movement of the supports 4′ toward their holding position, the supports lift the storage container 106 a height H sufficient to separate the storage container from the container accommodation, allowing the container transfer vehicle to move from its position below the storage container. Since the vertical lifting of the storage container 106 is obtained by the supports 4′, the container buffering assembly does not require a separate shuttle relative to which the container holder frame 3a may move in a vertical direction. Instead, the container holder frame 3a may be directly connected to the rails 9, in the same manner as described for the shuttles 8,8″ above, allowing for a horizontal movement between the first position below the first port column 119 and a second position.

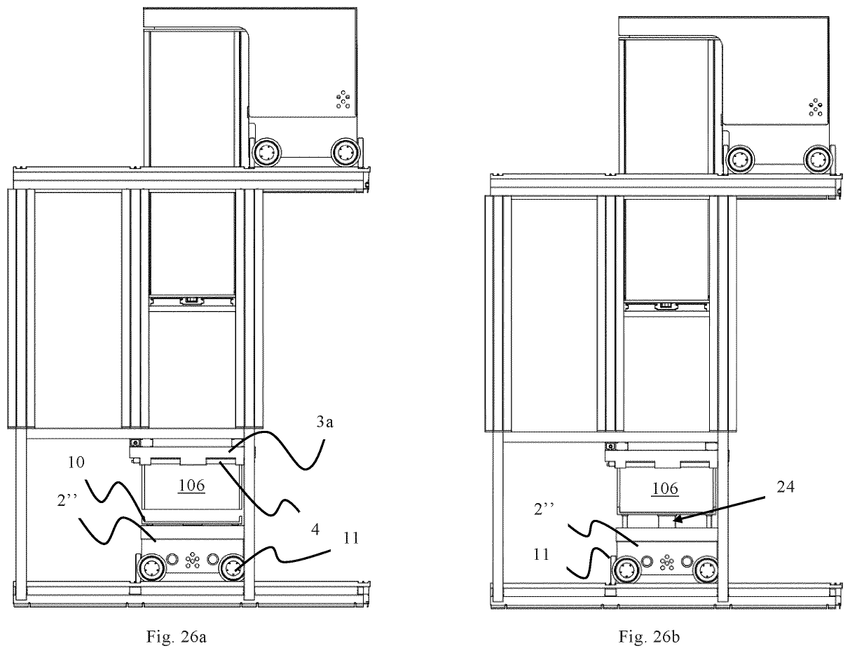

A sixth exemplary embodiment of a storage system according to the invention is shown in FIGS. 26a/b. The container holder frame 3a and its connection to the rails 9 may e.g. be as described for the fifth embodiment. However, the supports 4 are not required to lift a storage container 106 by themselves since the container transfer vehicle 2″ comprises a container accommodation 10 being vertically moveable by an actuator assembly 24. The vertical movement of a storage container between the container accommodation 10 and a container holder frame 3a may then be obtained by raising or lowering the container accommodation 10. In an alternative embodiment, the container accommodation 10 may be raised and/or lowered by raising or lowering one of the set of wheels 11,11′ of the container transfer device, i.e. similar to the vertical wheel movements of the prior art container handling vehicles 201,301,401 described above.

The storage systems according to the invention may for instance be obtained by installing the container buffering assembly at the lower end of at least one port column of a storage system. Alternatively, the container buffering assembly 10 may comprise the at least one port column and be added to an available sidewall of a storage system.

### LIST OF REFERENCE NUMBERS

1 Prior art automated storage and retrieval system
2,2′,2″ Container transfer vehicle
3a,3b Container holder frame
4 Supports, pivotable pins
5 Supports, clamps
6 Upper end of a port column
7 Lower end of a port column
8,8′ Shuttle
9 Rails for shuttle
Container accommodation
11,11′ Wheels of container transfer vehicle
12 Screw, for horizontal movement of shuttle
13 Screw, for vertical movement of container holder frame
14 Electric motor, for vertical movement of container holder frame
15 Electric motor, for horizontal movement of shuttle
16 Lifting band, spoolable lifting element
17 Lifting frame
18,18′ Rotary shaft
19 Guide pin
20 Electric motor
21 Corner section
22 Horizontal ceiling profile
23 Vertical support profile
24 Actuator assembly for container accommodation
25 Outer rib of a storage container
26 Gripper (on lifting frame)
27 [symbol]
100 Framework structure
102 Upright members of framework structure
103 Horizontal members of framework structure
104 Storage grid
105 Storage column
106 Storage container
106′ Particular position of storage container
107 Stack
108 Rail system, on top of storage grid
109 Rail system, below port columns
110 Parallel rails in first direction (X)
110a First rail in first direction (X)
110b Second rail in first direction (X)
111 Parallel rail in second direction (Y)
111a First rail of second direction (Y)
111b Second rail of second direction (Y)
112 Access opening
119 First port column
120 Second port column
121 Third port column
122 Fourth port column
123 Fifth port column
124 Sixth port column
201 Prior art container handling vehicle
201a Vehicle body of the container handling vehicle 201
201b Drive means/wheel arrangement, first direction (X)
201c Drive means/wheel arrangement, second direction (Y)
301 Prior art cantilever container handling vehicle
301a Vehicle body of the container handling vehicle 301
301b Drive means in first direction (X)
301c Drive means in second direction (Y)
401 Prior art container handling vehicle
401a Vehicle body of the container handling vehicle 401
401b Drive means in first direction (X)
401c Drive means in second direction (Y)
Y Second direction
Z Third direction

1. A storage system comprising a framework structure in which storage containers can be stored, a container lift device, and a container transfer device, the framework structure comprises at least a first port column (119) through which a storage container may be transferred to or from the container transfer device by the container lift device,
the first port column comprises an upper end, at which the container lift device is arranged when a storage container is to be lowered or lifted through the port column, and a lower end at which a container buffering assembly is arranged, wherein
the container buffering assembly features a container holder frame comprising a plurality of supports,
the container holder frame is horizontally moveable between a first position under the lower end of the first port column and a second position away from the lower end of the first port column;
the supports are actuatable between a holding position, in which the supports are configured to support a storage container, and a release position, in which a storage container may pass through the container holder frame in a vertical direction.

2. The storage system according to claim 1, wherein at least parts of the container holder frame are vertically movable, or the container transfer device comprises a vertically moveable container accommodation, for transferring a storage container between the container holder frame and the container transfer device.

3. The storage system according to claim 1, wherein the container holder frame is vertically movable between a lower position, in which a storage container is transferable between the container holder frame and the container transfer device, and an upper position, in which the container transfer device may move below a storage container held by the container holder frame.

4. The storage system according to claim 1. wherein at least parts of the supports are vertically movable between a lower position, in which a storage container is transferable between the container holder frame and the container transfer device, and an upper position, in which the container transfer device may move below a storage container held by the container holder frame.

5. The storage system according to claim 1, wherein the container holder frame has an inner periphery configured to allow passage of a storage container in a vertical direction when the supports are in the release position.

6. The storage system according to claim 1, wherein the container buffering assembly comprises rails arranged at the lower end of the first port column, and the container holder frame is moveably connected to the rails such that the container holder frame may move in the horizontal direction between the first position and the second position.

7. The storage system according to claim 1, wherein the container buffering assembly comprises a shuttle to which the container holder frame is connected, the shuttle is arranged to move the container holder frame in a horizontal direction between the first position and the second position.

8. The storage system according to claim 3, wherein the container buffering assembly comprises a shuttle to which the container holder frame is connected, the shuttle is arranged to move the container holder frame in a horizontal direction between the first position and the second position, and
wherein the container holder frame is vertically movable relative to the shuttle between the lower position and the upper position.

9. The storage system according to claim 8, wherein the container holder frame is connected to the shuttle by an actuator assembly arranged to move the container holder frame between the lower position and the upper position.

10. The storage system according to claim 7, wherein the shuttle has an inner periphery configured to allow passage of a storage container in a vertical direction.

11. The storage system according to claim 7, wherein the container buffering assembly comprises rails arranged at the lower end of the first port column, and the shuttle is moveably connected to the rails such that the container holder frame may move in the horizontal direction between the first position and the second position.

12. The storage system according to claim Z, wherein the shuttle is pivotably connected to a rotary shaft having a vertical axis adjacent to the first port column, such that the container holder frame may rotate between the first and the second position.

13. The storage system according to claim 1, wherein the framework structure comprises a second port column through which a storage container may be transferred by the container lift device, and the second position of the container holder frame is under a lower end of the second port column.

14. The storage system according to claim 1, comprising a third port column and a second container holder frame, the second container holder frame is horizontally moveable between a first position under the lower end of the third port column and a second position away from the lower end of the third port column.

15. The storage system according to claim 1, wherein the container transfer device is a container transfer vehicle comprising wheels, for horizontal movement of the container transfer vehicle, and a container accommodation upon which a storage container may be supported.

16. The storage system according to claim 1, wherein the container lift device comprises a lifting assembly which is suspended from one or more spoolable lifting elements and is arranged to be raised or lowered in order to raise or lower a releasably attached storage container within the port column.

17. The storage system according to claim 1, wherein the framework structure comprises an upper rail system, and the container lift device is a container handling vehicle comprising at least one set of wheels for moving the container handling vehicle in a horizontal direction on the upper rail system.

18. A container buffering assembly for a storage system, the storage system comprising a framework structure, in which storage containers can be stored, a container lift device, and a container transfer device, the framework structure defining at least a first port column through which a storage container may be transferred by the container lift device; wherein
the container buffering assembly comprises a container holder frame;
the container holder frame is moveably connectable at a lower end of the first port column such that the container holder frame may move in a horizontal direction between a first position under the lower end of the first port column and a second position away from the lower end of the first port column; and
the container holder frame comprises a plurality of supports, the supports being actuatable between a holding position, in which the supports are configured to support a storage container, and a release position, in which a storage container may pass through the container holder frame in a vertical direction.

19. A container buffering assembly, wherein at least parts of the container holder frame are vertically movable for transferring a storage container between the container holder frame and the container transfer device.

20. The container buffering assembly according to claim 18, comprising a shuttle, wherein
the container holder frame is connected to the shuttle by an actuator assembly, and the shuttle is moveably connectable at the lower end of the first port column such that the container holder frame and the shuttle may move in the horizontal direction between the first position and the second position; and
the actuator assembly is arranged to vertically move the container holder frame relative to the shuttle between the lower position, in which a storage container is transferable between the container holder frame and the container transfer device, and an upper position, in which the container transfer device may move below a storage container held by the container holder frame.

21. The container buffering assembly according to claim 18, comprising a set of rails, the rails are connectable at the lower end of the first port column, and the container holder frame is moveably connected to the set of rails, optionally via the shuttle, such that the container holder frame may move in the horizontal direction between the first position and the second position.

22. A method of transferring storage containers in a storage system comprising a framework structure in which storage containers can be stored, a container lift device, and a container transfer device, the framework structure comprises at least a first port column through which a storage container may be transferred to or from the container transfer device by the container lift device,
the first port column comprises an upper end, at which the container lift device is arranged when a storage container is to be lowered or lifted through the port column, and a lower end at which a container buffering assembly is arranged, wherein
the container buffering assembly features a container holder frame comprising a plurality of supports;
the container holder frame is horizontally moveable between a first position under the lower end of the first port column and a second position away from the lower end of the first port column;
the supports are actuatable between a holding position, in which the supports are configured to support a storage container, and a release position, in which a storage container may pass through the container holder frame in a vertical direction, the method comprising:
moving the container holder frame to the first position;
moving a container transfer device, carrying a first storage container (106), to a position below the first port column;
lowering the container holder frame towards the container transfer device, or vertically raising a container accommodation of the container transfer device, while the supports are in the release position;
actuating the supports into the holding position to support the first storage container;
lifting the container holder frame and the first storage container towards the lower end of the port column, or lowering the container accommodation of the container transfer device; and
moving the container holder frame and the first storage container to the second position.

23. The method according to claim 22, comprising lowering a second storage container via the first port column to the container transfer device by use of the container lift device when the container holder frame and the first storage container has been moved to the second position.

24. The method according to claim 23, comprising moving the container transfer device and the second storage container away from the first port column.

25. The method according to claim 24, comprising moving the container holder and the first storage container to the first position, and retrieving the first storage container by use of the container lift device.
